(19) United States
(12) Patent Application Publication
(10) Pub. No.: US 2003/0175586 A1
(43) Pub. Date: Sep. 18, 2003

(54) Square top

(76) Inventor: Donald J. E. Miller JR., Tampa, FL (US)

Correspondence Address: Donald J. E. Miller, Jr., 6509 Secrest Ct., Tampa, FL, 33625, US

(21) Appl. No.: 10/358,435

(22) Filed: Feb. 4, 2003

Related U.S. Application Data
(63) Continuation-in-part of application No. 09/972,625, filed on Oct. 9, 2001.

(51) Int. Cl. H01M 2/02

(52) U.S. Cl. 429/176; 429/187

(57) ABSTRACT

Square top is a battery octanguler in shape which prevents the batteries from rolling if dropped or laid down, with a adhesive coating having four strips on four sides and are used to allow the battery to be lifted from place.

### FIELD OF THE INVENTION

The square top relates to alkaline batteries, being made octanguler shaped and having a lift coat plus come in various sizes. The shape of the batteries keep them from rolling away when they are lying down, and they can be stacked to consolidate space.

### BACKGROUND

An alkaline battery with an octanguler body and incorporating a lift coat. The shape allows better handling of the battery and the lift coat is convenient when removing batteries from various products.

### SUMMARY

The square top can be used like other alkaline batteries, and comes in sizes like D, C, AA and AAA ect. Unlike other batteries the square top is octanguler shaped and will not roll away when it's laid down. The lift coat on the battery is made of a rubber or plastic non-corrosive substance and fits over the battery like a coat. This coat has a sticky film on it so it's easier to grasp, and the lift coat has a lift strip on four sides.

The strips on the coat are cut at the bottom and sides, but left intact at the top. If the battery is corroded a strip can be lifted and the battery can be pulled from its place and discarded.

### DESCRIPTION OF DRAWINGS

Page 1. Shows the Square Top in its completed form.

Page 2. Is the top and bottom view of the battery.

Page 3. Shows the side view of the square top, from the top and bottom plus the lift coat.

Page 4. Shows the square top battery cut in half.

It is to be understood that the present invention is not limited to the details of construction and arrangement of parts illustrated in the accompanying drawings, since the invention is capable of other embodiments, and is capable of being practiced or carried out in various ways within the scope of the claims. Also, it is to be understood, that the phraseology and terminology employed herein is for the purpose of description, and not of limitation.

### DESCRIPTION OF INVENTION

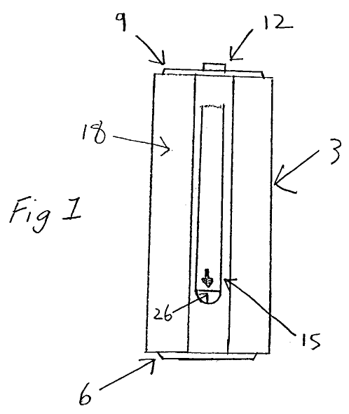

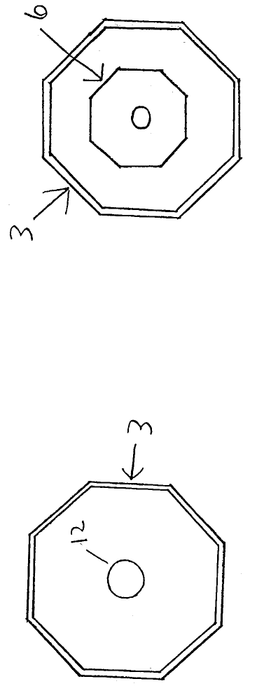

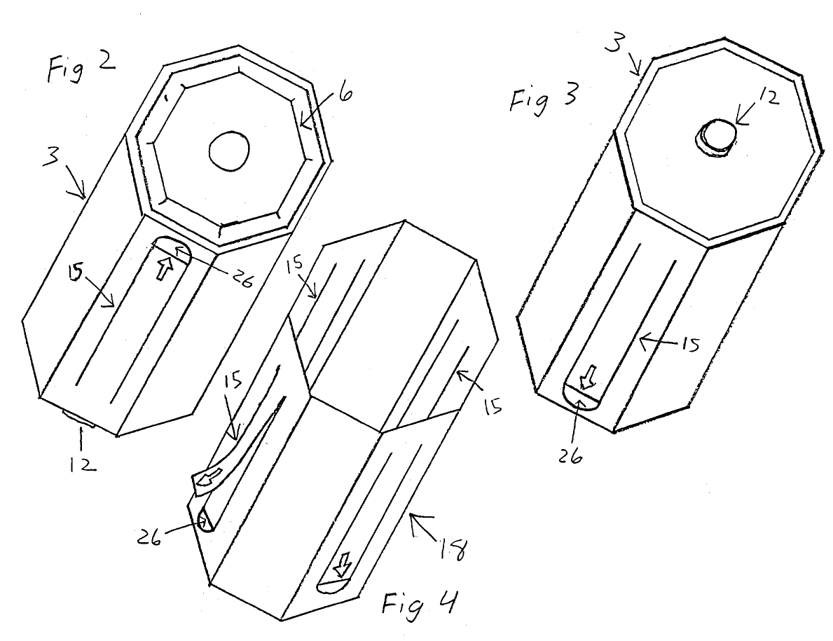

FIG. 1 shows a completed Square Top, it's an alkaline battery octanguler in shape and having a lift coat 18 for continence, and FIGS. 2 and 3 are perspectives of the battery.

Page 2. shows the batteries positive and negative caps. The body is made octanguler shaped with metal negative caps on the bottom 6 and a positive on the top 9, with each cap consisting of a current collector 12 and 24. The lift coat 18 fits over the battery like a clove and is used to remove the battery if necessary.

The making of the square top begins with the body 3, made of a thin metal and shaped into an octanguler form and held together with a adhesive such as solder. Next is the positive cap with a protruding top 9, and in the top center of that is the current collector tip 12. The negative cap is also made of metal with a protruding bottom 6, connected to the inside center of the cap is a current collector rod 24, and both the positive and negative caps are also octanguler shaped. The separator 22 is a thin sheet of metal that keeps the chemicals inside from mixing together, and has the same shape as the battery body.

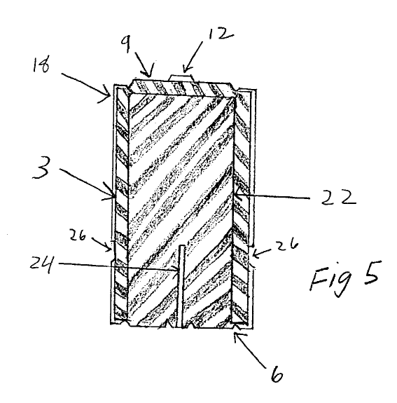

The lift coat FIG. 4. is then made with a plastic or rubber adhesive, and on four sides there are two groves cut down the length of the coat and one grove cut across to connecting the two longer cuts making the lift strips 15. At the bottom of each strip is a half cut moon 26 that is removed to allow the lift strip to be pulled from its bed.

01. A alkaline battery, made octanguler in shape and size.

02. An alkaline battery according to claim 01, wherein said battery has a lift coat with lifting strips.
